(19) United States
(12) Patent Application Publication
(10) Pub. No.: US 2022/0171260 A1
(43) Pub. Date: Jun. 2, 2022

(54) ATTACHMENT TO A TRIPOD TO PROVIDE A SIMPLE WAY TO ATTACH A BALLAST WEIGHT FOR STABILITY

(71) Applicant: Scott David Dordick, La Verne, CA (US)

(72) Inventor: Scott David Dordick, La Verne, CA (US)

(21) Appl. No.: 17/109,051

(22) Filed: Dec. 1, 2020

(51) Int. Cl. G03B 17/56; F16F 15/28

(52) U.S. Cl. CPC G03B 17/561; F16F 15/28

(57) ABSTRACT

An attachment to photographic tripod to easily attach and tension a rope that is attached on the opposite end to a weight or ballast. This weight or ballast will add stability to the tripod. In many instances a photographer will have a camera bag that will provide the necessary weight or ballast. The three tapered slots allow a rope to be quickly and easily wound through the preferred embodiment of the invention and the weight is tensioned and secured just by pulling down on the rope and engaging it further down into the tapered slots.

### BACKGROUND OF THE INVENTION

### 1. Field of the Invention

The present invention is related to an improvement to a tripod supporting a photographic instrument such as a camera and lens.

### 2. Description of Prior Art

Tripods have been around for hundreds of years and with the advent of photography in 1800's tripods were mandatory because of the long exposures required by the lack of light sensitivity of the early photographic materials available at the time.

Ballast weight is sometimes added to a tripod to add stability tripod. There is a significant need to have a quick and easy way to add weight to add stability to a tripod.

### SUMMARY OF THE INVENTION

Tripods are often used to support cameras for photography to help keep the camera stable and avoid movement during the exposure. Movement during the exposure can cause blurry images. If you have two tripods of the same design, the heavier one will be more stable. Because photographers do not want to carry the extra weigh of a heavy tripod, tripod manufacturers have added a hook to hang a camera bag from the center column of the tripod. A camera bag hanging from a tripod adds weight to the tripod. If the bag is hanging without touching the ground it can move around in the wind and act like a pendulum and cause additional tripod movement. Some photographers will use a rope to tie their camera bag to their tripods allowing them to have most of the camera bags weight on the tripod but leaving enough weight on the ground to keep the bag from moving in the wind. This is a good solution, but it is difficult to tie a rope at exactly the right length to get the desired amount of weight of the tripod and on the ground.

The present invention allows you to quickly attach a camera bag or other object that has a rope attached to it, to your tripod and and to be able pull on the rope and obtain the desired tension and then quickly and easily lock the tensioned rope in place to get the desired amount of weight distribution between the tripod and the ground.

The present invention is a device that is intended to be a part of a photographic or other tripod either as an accessory or as an integral part of the tripod assembly. The present invention will be preferably on the center point below where the camera attaches. Often there is a vertical tube under the camera (called a center column) the center column allows the camera to slide up and down. My invention would often be attached to the bottom of the center column, if the tripod is equipped with a center column. If there is no center column then it would be mounted at another point preferably under the attachment point of the camera. Because the attachment point of the rope is on the center column or on the center of the camera that is located in the middle of the tripod. This will help to keep the weight of the camera bag distributed equally on the tripods 3 legs.

To use the present invention, a camera bag with a rope of a diameter that will lock into the tapered slots of the present invention is tied to a handle or other secure point on the camera bag that is set on the ground under the middle of the tripod.

The present invention comprises a device that is attached to or built into a tripod and has a series of tapered slots to wind a rope through and lock it into place. The slots are tapered so the more the rope is pulled into them the tighter the present invention will hold the rope. The slots are arranged in a way so the rope locks into place just by winding the rope through the slots and it will lock the rope into place without requiring the rope to be looped or knotted in any way. It is preferred to have the center-line of at least one of the slots the angled slots to be between vertical and 45 degrees upward so the weight of the camera bag will pull the rope down into the slot.

### BRIEF DESCRIPTION OF THE DRAWINGS

Referring particularly to the drawings for the purpose of illustration only and not limitation, there is illustrated.

FIG. 1 is a perspective view of the preferred embodiment of a tripod cleat.

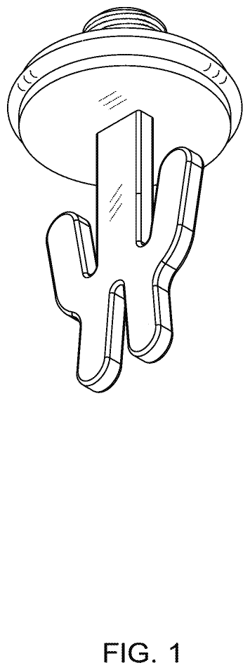

FIG. 2 is a front view of the preferred embodiment of a tripod cleat.

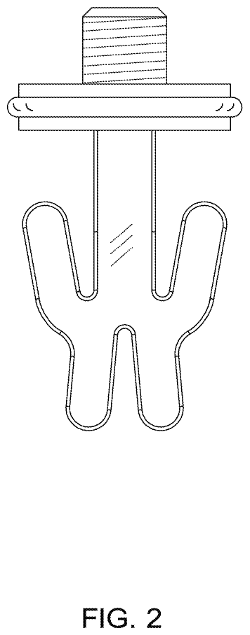

FIG. 3 is a front view of the preferred embodiment of a tripod cleat with a rope attached.

FIG. 4 is a side view of the preferred embodiment of a tripod cleat.

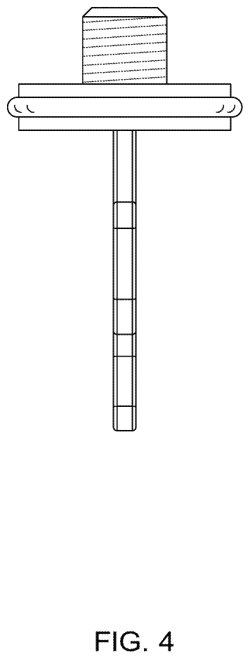

### DETAILED DESCRIPTION OF THE PREFERRED EMBODIMENTS

Although specific embodiments of the present invention will now be described with reference the downswings, it should be understood that such embodiments are by way of example only and merely illustrative of but a small number off the many possible specific embodiments which can represent applications of the principles of the present invention. Various changes and modification obvious to one skilled in the art to which present pertains are deemed to be within the spirit, scope and contemplation of the present invention as further defined in the appended claims.

As illustrated in Figures, 1, 2, 3, and 4, the present invention, has a thread 2, to attache to the center column or apex of a tripod.

The preferred embodiment has three tapered slots where two tapered slots open upwards 3, 4, and one tapered slot opens downwards 5.

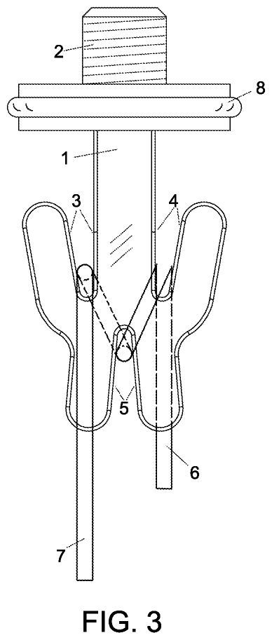

As illustrated in FIG. 3 the slots are arranged so that a rope can be easily wound through the slots and locked into place simply by pulling the rope down deeper into the slots. One end of the rope goes to the ballast or weight 7 and the other end of the rope 6 is pulled thru the slots.

A rubber ring 8, on the outside diameter is there to work as a cushon to protect the tripod legs from contacting the body 1, of the present invention.

What is claimed is:

1. An attachment to a tripod comprising:
a. a means of attachment, to the center column or apex of a tripod. The preferred embodiment is illustrated with a threaded attachment, but this not intended to limit this to the only means of attachment.
b. three tapered slots where two tapered slots open upwards 3, 4, and one tapered slot opens downwards 5.
c. the slots are arranged so that a rope can be easily wound through the slots and locked into place simply by pulling the rope 6, down deeper into the slots.
